(19) United States
(12) Patent Application Publication
(10) Pub. No.: US 2014/0179195 A1
(43) Pub. Date: Jun. 26, 2014

(54) Building Blocks and a Wand Having Magnetic Properties Therefor

(71) Applicant: Steven D. Kramer, Altamonte Springs, FL (US)

(72) Inventor: Steven D. Kramer, Altamonte Springs, FL (US)

(21) Appl. No.: 14/071,519

(22) Filed: Nov. 4, 2013

Related U.S. Application Data
(60) Provisional application No. 61/740,382, filed on Dec. 20, 2012.

(51) Int. Cl. A63H 33/06; B25J 1/04

(52) U.S. Cl. CPC A63H 33/06; B25J 1/04
USPC 446/128; 294/190

(57) ABSTRACT

A toy combination includes a plurality of children's building blocks, each of the building blocks having a ferromagnetic material, and a wand with at least a portion that is magnetic, the wand capable of attracting the plurality of children's building blocks. The wand may have end lower ends in a variety of configurations to pick up the building blocks.

### REFERENCE TO RELATED CASE

This application claims priority under 35 U.S.C. §119 (e) to provisional application No. 61/740,382, filed on Dec. 20, 2012, which is hereby incorporated by reference in its entirety.

### BACKGROUND OF THE INVENTION

### Field of the Invention

The present invention relates to building blocks and a wand that can be used to collect and/or pick up the building blocks.

Building blocks have been known and used to keep children busy in imaginative play for years. The building blocks come in buckets or containers that usually include hundreds of the building blocks and the building blocks can be assembled in any number of configurations. Children have also been able to collect the building blocks in sets and for specific projects or buildings/characters. However, when the children are done, the building blocks are usually spread all over the room(s) and need to be picked up and put away. However, picking up each of the individual pieces can be time-consuming and can be a struggle to get the children to pick up their own toys.

Thus, a way to collecting and picking up the building blocks is needed to assist usually tired and overworked parents and eliminate at least one argument in the household.

### SUMMARY OF THE INVENTION

The present invention is directed to a toy combination that includes a plurality of children's building blocks, each of the plurality of children's building blocks having a ferromagnetic material, and a wand having at least a portion that is magnetic, the wand capable of attracting the plurality of children's building blocks.

In some embodiments, the ferromagnetic material is a plurality of ferromagnetic pieces.

In some embodiments, the ferromagnetic material is in a powder form.

In some embodiments, the ferromagnetic material is in a particulate form.

In yet another aspect, the present invention is directed to a wand for attracting building blocks with a ferromagnetic material therein that a first end, the first end being a handle for the wand, a second end, the second end having at least a portion that is magnetic to attract the building blocks with the ferromagnetic material, and an extended portion extending between the first and second ends.

In some embodiments, the second end of the wand has a generally disc-shaped configuration.

In other embodiments, the second end of the wand is generally rectangular in cross section.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description of the present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1 is a plan view of one embodiment of a wand having magnetic properties and the building blocks that can be attracted to the wand according to the present invention;

FIG. 2 is a cross section of a generic building block showing the ferromagnetic material therein;

FIG. 2A is a cross section of another generic building block showing the ferromagnetic material as a single piece of ferromagnetic material;

FIG. 2B is a cross section of another generic building block showing the ferromagnetic material as a two pieces of ferromagnetic material in the building block;

FIG. 3 is a plan view of another embodiment of a wand having magnetic properties and the building blocks that can be attracted to the wand according to the present invention; and

FIG. 4 is a plan view of one embodiment of a wand having magnetic properties and the building blocks that can be attracted to the wand according to the present invention.

### DETAILED DESCRIPTION OF THE PREFERRED EMBODIMENTS

Reference will now be made in detail to the present preferred embodiment(s) of the invention, examples of which are illustrated in the accompanying drawings. Whenever possible, the same reference numerals will be used throughout the drawings to refer to the same or like parts.

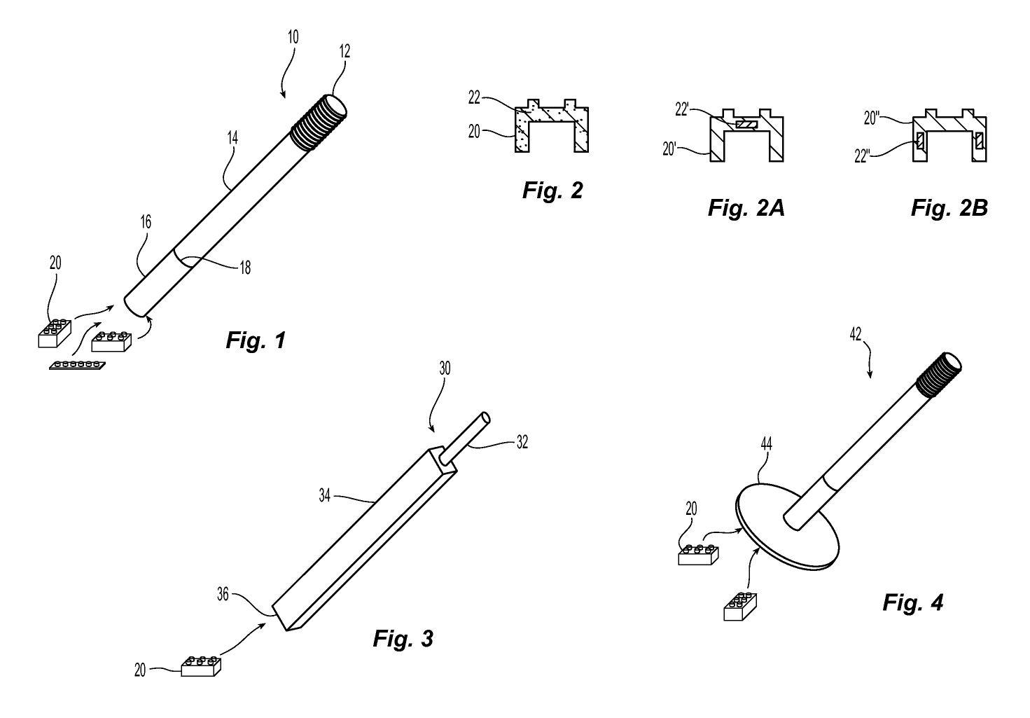

FIG. 1 shows a first embodiment of a wand 10 according to the present invention. The wand 10 has magnetic properties. The wand 10 is used in conjunction with building blocks 20, which have a ferromagnetic material (See FIGS. 2, 2A, and 2B). The wand 10 has a handle 12, an extended portion 14 extending from the handle 12 to a magnetic portion 16 at the end of the wand 10. While the three portions (12,14,16) of the wand 10 are explicitly illustrated in FIG. 1, the extended portion 14 and the magnetic portion 16 may appear to be a single, integral portion without the line 18. The magnetic portion 16 may be as large (e.g., 50% of the length of the wand) or small (only at the end of the wand 10) as the user would like. In FIG. 1, the wand 10 has an oval cross section, but it could have any appropriate cross section, including for example, round, square, or simply elongated with a number of discrete sides, e.g., hexagonal, pentagonal, etc.

The building blocks 20, illustrated in cross section in FIGS. 2, 2A, and 2B could be of any style, size, shape, configuration or from any maker, e.g., Legos, Mega Bloks, etc., with a ferromagnetic material 22 that is attracted to the wand 10. The ferromagnetic material 22 may be of any appropriate materials for the purpose of inclusion in the building blocks 20. The ferromagnetic material 22 may be molded in the building blocks in a number of ways. The ferromagnetic material may be included as a single piece as ferromagnetic material 22′ as in FIG. 2A, or multiple pieces as ferromagnetic material 22″ as in FIG. 2B. The ferromagnetic material 22 is depicted as a powder or smaller particles (particulates) in FIG. 2. The ferromagnetic materials 22, 22′ and 22″ should be sufficiently encapsulated in the building blocks 20 so as prevent the ferromagnetic material from being exposed to the children using the building blocks 20.

FIG. 3 illustrates a second embodiment of a wand 30 according to the present invention. The wand 30 has a handle 32 that is attached to an elongated magnetized portion 34. The magnetized portion 34 may extend from a bottom end 36 all the way to the handle 32, or just a portion thereof. The magnetized portion 34 section of wand 30 has a generally rectangular cross section, and the relative sizes of the small and larger axis may be of any ratio. Thus, the magnetized portion 34 may be thin and wide, or closer to a square shape.

FIG. 4 illustrates yet another embodiment of a wand 40 according to the present invention. The wand 40 has a handle portion 42 that is relatively longer than the other embodiments and has a magnetized portion 44 at the end of the handle portion 42. As illustrated, the magnetized portion 44 is a flat, disk-shaped portion. However, the magnetized portion 44 may be of any shape or configuration at the end of handle portion 42 and be within the scope of the present invention. For example, the magnetized portion 44 may be a spherical shape, a square or rectangular shape, etc. The wands 10, 30, and 40 allow a parent or even a child to essentially “scoop-up” the building blocks 20 based on the magnetic attraction between the wands and the building blocks. The magnetized portions of the wands may be of any shape or configuration, limited only by weight (should allow for small children to be able to manipulate them), size (if they are too large, they may not fit in corners to get the blocks or be hard to store), and configuration (shapes with sharp corners may accidentally damage walls, furniture, or children).

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

I claim:

1. A toy combination comprising:
a plurality of children's building blocks, each of the plurality of children's building blocks having a ferromagnetic material; and
a wand having at least a portion that is magnetic, the wand capable of attracting the plurality of children's building blocks.

2. The toy combination according to claim 1, wherein the wand is an elongate element extending between a first end and a second end, the first end having a handle and the second end having the magnetic portion.

3. The toy combination according to claim 1, wherein the second end has a configuration that is the same as the first end and an extended portion between the first and second ends.

4. The toy combination according to claim 1, wherein the second end has a generally disc-shaped configuration.

5. The toy combination according to claim 1, wherein the second end is generally rectangular in cross section.

6. The toy combination according to claim 1, wherein the ferromagnetic material comprises a plurality of ferromagnetic pieces.

7. The toy combination according to claim 1, wherein the ferromagnetic material is a powder.

8. The toy combination according to claim 1, wherein the ferromagnetic material comprises particulates.

9. A wand for attracting building blocks with a ferromagnetic material therein comprising:
a first end, the first end being a handle for the wand;
a second end, the second end having at least a portion that is magnetic to attract the building blocks with the ferromagnetic material; and
an extended portion extending between the first and second ends.

10. The wand according to claim 9, wherein the second end has a configuration that is the same as the first end and the extended portion between the first and second ends.

11. The wand according to claim 9, wherein the second end has a generally disc-shaped configuration.

12. The wand according to claim 9, wherein the second end is generally rectangular in cross section.
